(19) United States
(12) Patent Application Publication
(10) Pub. No.: US 2023/0268093 A1
(43) Pub. Date: Aug. 24, 2023

(54) RADIOACTIVE WASTE CONTAINER

(71) Applicant: BREEZE INVEST GMBH, Vienna (AT)

(72) Inventor: Peter Krumhoff, Torgelow (DE)

(21) Appl. No.: 18/024,416

(22) PCT Filed: Sep. 8, 2021
(86) PCT No.: PCT/EP2021/074693

§ 371 Date: Mar. 2, 2023

(30) Foreign Application Priority Data
Sep. 8, 2020 (LU) LU102056

(51) Int. Cl. G21F 5/08

(52) U.S. Cl. CPC G21F 5/08

(57) ABSTRACT

A radioactive waste container comprises an essentially box-shaped hollow container body that has six container sides, comprising an opening side that comprises an opening into the hollow container body. In the corner areas at which the container sides join, at least one fixation is located, and wherein the opening is adapted to be closed with a lid, wherein each corner area adjacent to the opening is at least partially spaced from the opening by means of a recess in the opening side.

### FIELD

The present invention relates to waste containers. In particular, the present invention relates to a radioactive waste container.

### BACKGROUND

In the field of waste containers, the predominant shape is a box-shaped container that comprises on its topside at least one circular lid. The (main) lid seals off the interior hollow portion (storage room) of the container from the outside. A second cover lid may be applied to cover and protect the main lid. A such container is produced for example by the company GNS under the name of “Yellow Box”. Document U.S. Pat. No. 6,809,329 B1 discloses a welded container for receiving toxic waste, where a top plate is welded to the structure of leg members. Document WO 2013121046 A1 discloses a cast storage container.

The currently available containers are cumbersome in handling (e.g. loading with waste) due to the relatively small and circular lid that in turn is necessary due to stability constraints.

### SUMMARY

It is the objective of the present application to provide a container that eases handling. The objective is attained by the features of the appended independent claim.

According to an aspect of the present application, a radioactive waste container comprises an essentially box-shaped hollow container body. Said container body has six container sides, wherein in at least one corner area where the container sides join at least one fixation is located. That is, container sides join in a corner area and of all corner areas at least one fixation is located in one of said corner areas. Further, at least one container side comprises an opening adapted to be closed with a lid for accessing and sealing the hollow interior of the container. Each corner area adjacent to the opening is at least partially spaced from the opening by means of at least one recess. That is, between the corner area or fixation on the container side comprising the opening and said opening, at least one recess is located. The recess may be a groove, for example. This may have the advantage that the opening may be designed larger than in conventional radioactive waste containers because the corners or fixations are decoupled to some extend from the surface with the opening. As a result, when dropping the container onto a corner or fixation at the surface or side with the opening, the corner/fixation adsorbs at least a part of the energy and most likely breaks away and/or deforms. The remaining structure is protected by such sacrificial design by means of the recess and also the opening and attached lid are protected and remain sealed. The recess may be a predetermined breaking and/or weak point.

Said fixations may be known container locks for receiving twist locks or any other means to fixate the container to another structure (also using intermediary structures).

According to another aspect of the present application, outside surfaces of the corners of a radioactive waste container span a (virtual) first enveloping body and outside surfaces of the container sides span a (virtual) second enveloping body. Further, the second enveloping body is smaller than the first enveloping body. That is, the second enveloping body is located inside the first enveloping body. This may have the advantage that machining the entire outside surfaces of the container can be avoided and said sacrificial design of the corners or fixations is further improved.

According to another aspect of the present application, at least the container body is made from ductile cast iron. This may have the advantage that the capabilities of the container to withstand stresses and, in particular, drops are further enhanced. Also, ductile cast iron is further beneficiary for the sacrificial design of the corners or fixations.

According to another aspect of the present application, the recess may comprise at least one rib that at least partially bridges the recess. This may have the advantage that the sacrificial properties of the sacrificial design of the corners or fixations may be adjusted more finely.

According to another aspect of the present application, the container further comprises a cover that is fitted into the opening. This may have the advantage that the lid is protected from environmental influences.

According to another aspect of the present application, the container comprises a collar that at least partially surrounds the cover and comprises at least one collar recess. This may have the advantage that the cover may be fitted and lifted more easily. Water (e.g. rain) can drain from the cover by means of the collar recess and does not get caught in the collar.

According to another aspect of the present application, the container further comprises at least one cross fixation in at least one of the corner areas. This may have the advantage that the containers may connected to neighboring containers when stacked. Further, a cross fixation may be used to drain a fixation next to it by fluidically connecting the fixation with the cross fixation. In other words, the cross fixation may be used to drain a fluidically connected fixation.

Each of the above aspects is to be considered an invention on its own. The aspects may be freely combined with each other and each feature not described as being dependent on another feature may also be freely combined with each other.

### BRIEF DESCRIPTION OF THE FIGURES

Further advantages and features of the present disclosure will be apparent from the appended figures. The figures are of merely informing purpose and not of limiting character. The figures schematically describe embodiments of the present application. Hence, the appended figures cannot be considered limiting for e.g. the dimensions of the present disclosure.

FIG. 1 schematically depicts a perspective view of a first embodiment of the present application.

FIG. 2 schematically depicts a top view of the embodiment of FIG. 1.

FIG. 3 schematically depicts a sectional view along the line A-A of FIG. 2.

FIG. 4 schematically depicts two (virtual) enveloping bodies.

FIG. 5 schematically depicts a perspective view of a second embodiment of the present application.

FIG. 6 schematically depicts a top view of the embodiment of FIG. 5.

FIG. 7 schematically depicts a sectional view along the line B-B of FIG. 6.

It is to be noted that in the different embodiments described herein same parts/elements are numbered with same reference signs, however, the disclosure in the detailed description may be applied to all parts/elements having the regarding reference signs. Also, the directional terms/position indicating terms chosen in this description like up, upper, down, lower downwards, lateral, sideward are referring to the directly described figure and may correspondingly be applied to the new position after a change in position or another depicted position in another figure. The containers of the different embodiments are depicted as standing on an even ground in an upright and normal position ready to use.

### DETAILED DESCRIPTION OF THE EMBODIMENTS

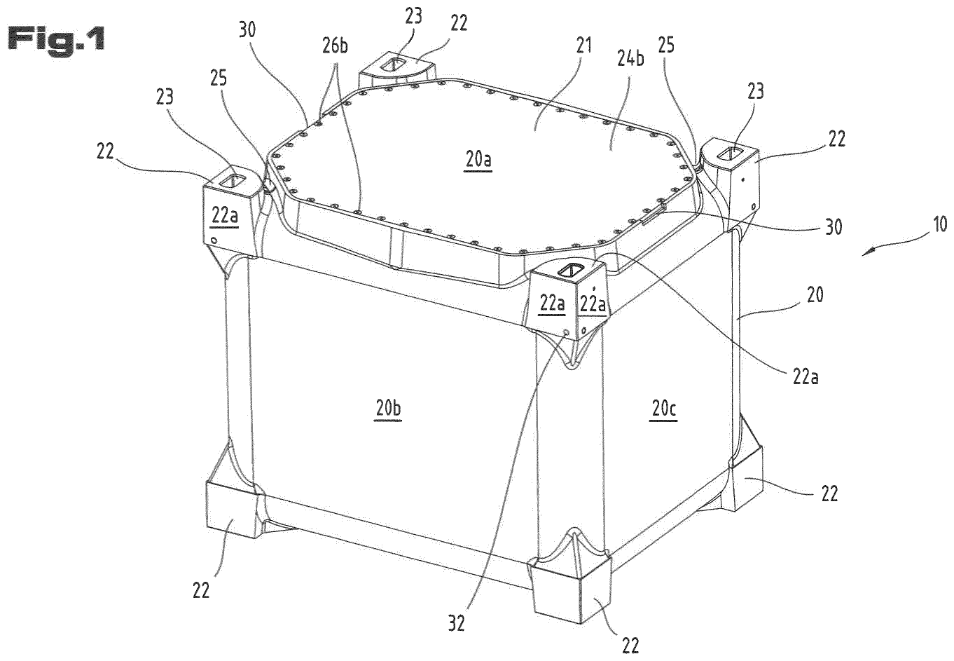

Initially referring to FIG. 1 a radioactive waste container 10 is depicted in a perspective view. The container 10 comprises a container body 20, a cover 24b and a lid 24a. The lid 24a covers an opening 21 in an opening side 20a. The opening side 20a is depicted in the upper part of FIG. 1. The container body 20 comprises six container sides 20a-f, wherein the top side or opening side is referenced with 20a, the bottom side with 20f and the sides of the shell are referenced with 20b-e. The container sides 20a-f respectively join each other in a corner area or at the corners 22. Known fixations 23 are located in said corner areas or at the corners 22.

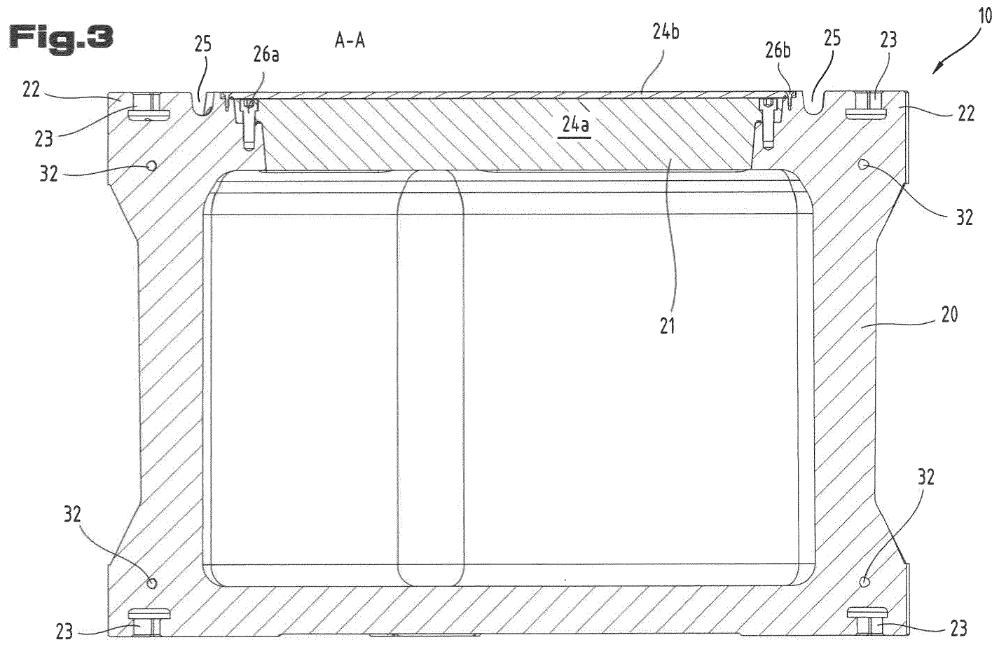

The container body 20 is essentially box shaped and hollow (see FIG. 3). The opening 21 provides access to the inside of the hollow container body 20. The opening 21 is conventionally closable and sealable with a lid 24a that is attached with screws 26a. The lid 24a and the screws 26a are covered by a cover 24b. The cover 24b is held by cover screws 26b. Said cover 24b is meant to protect the lid 24a from external influences in a known manner. A collar being unitary with the container body 20 surrounds the cover 24b and comprises two collar recesses 30.

The corners 22 an the upper side of the container 10 i.e. the corners 22 adjacent to the opening side 20a are separated from the opening 21 by recesses or grooves 25. The recesses or grooves 25 decouple the adjacent corners 22 and fixations 23 from the opening 21 and the lid 24a and provide a sacrificial design and/or predetermined breaking and/or weak point.

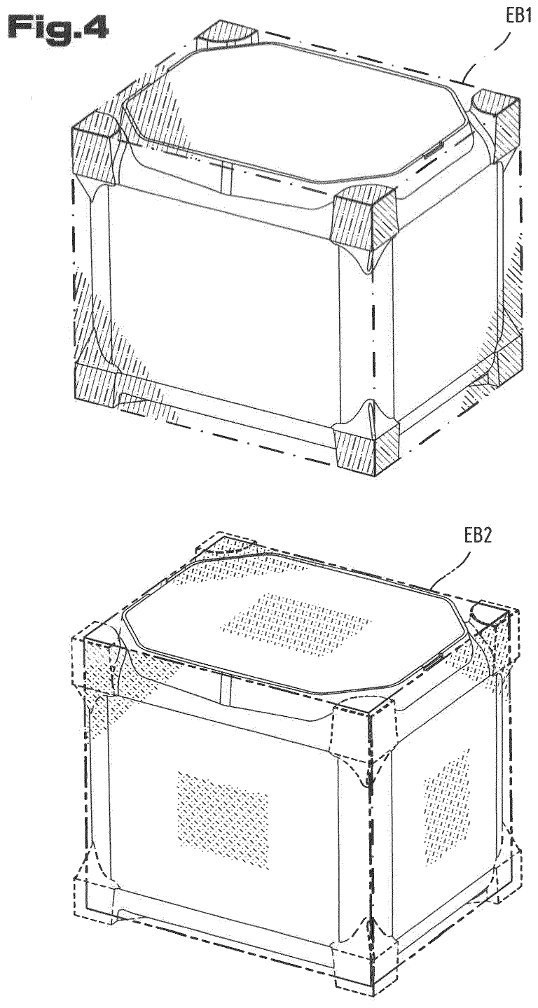

The container sides 20a-f are closer to a (geometrical) center point of the container 10 than the regarding and essentially parallel corners surfaces 22a. That is, if one would span a (virtual) first enveloping body EB1 with said corner surfaces 22a (see FIG. 4) and one would further span a (virtual) second enveloping body EB2 with the container sides 20a-f, the second enveloping body EB2 would be located inside the first enveloping body EB1. In other words, the container sides 20a-f are recessed with regard to the corner surfaces 22a, as can be seen in FIGS. 1, 3 and 4.

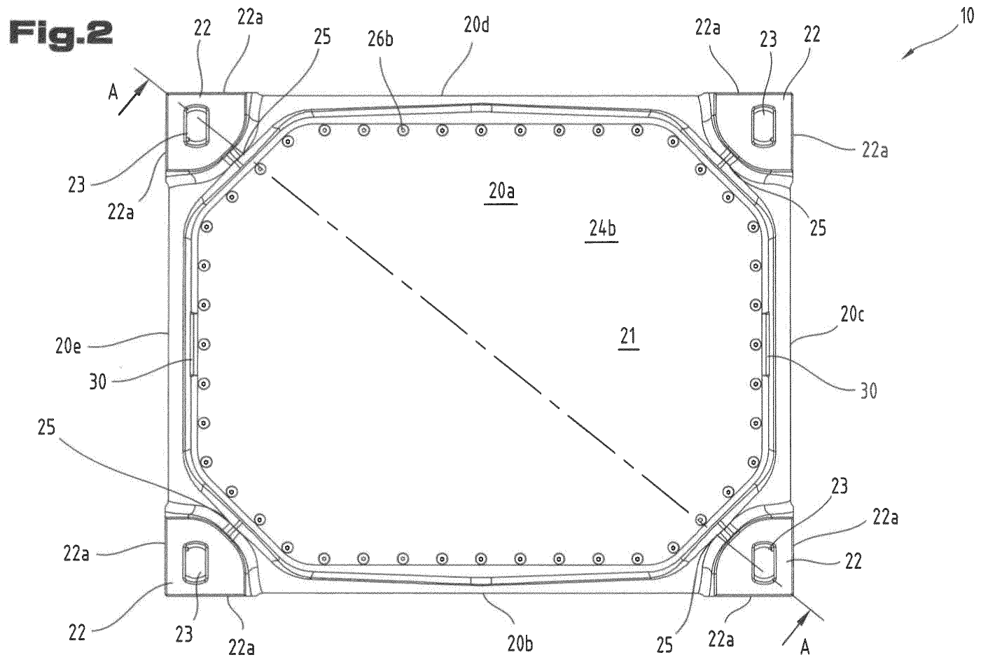

FIG. 3 depicts a sectional view along the line A-A of FIG. 2. Here also the recesses 25 and the recessed container sides 20a-f with regard to the corner surfaces 22a are visible. Further, the cross fixations 32 are visible.

Referring to FIGS. 2 and 3, the recesses 25 between the corners 22 and the opening 21 are visible. Further, the size and shape of the opening 21 is visible, being considerably larger than openings in conventional containers. The lid 24a and cover 24b essentially have the same size as the opening but for the space needed for the respective threading for the screws and sealing surfaces.

FIG. 4 depicts in the upper part the (virtual) first enveloping body EB1 that is spanned over all corners and/or surfaces of the corner areas. The lower part of FIG. 4 depicts the (virtual) second enveloping body EB2 that is spanned by the container sides, the opening side and the bottom side on which the container stands (not shown). Further, the first enveloping body EB1 is depicted in the lower part of FIG. 4 as dashed line in order to illustrate the second enveloping body EB2 is fully surrounded by the first enveloping body EB1 because the surfaces the second enveloping body EB2 coincide with the surfaces of the container that in turn are recessed with regard to the corner areas or corner surfaces.

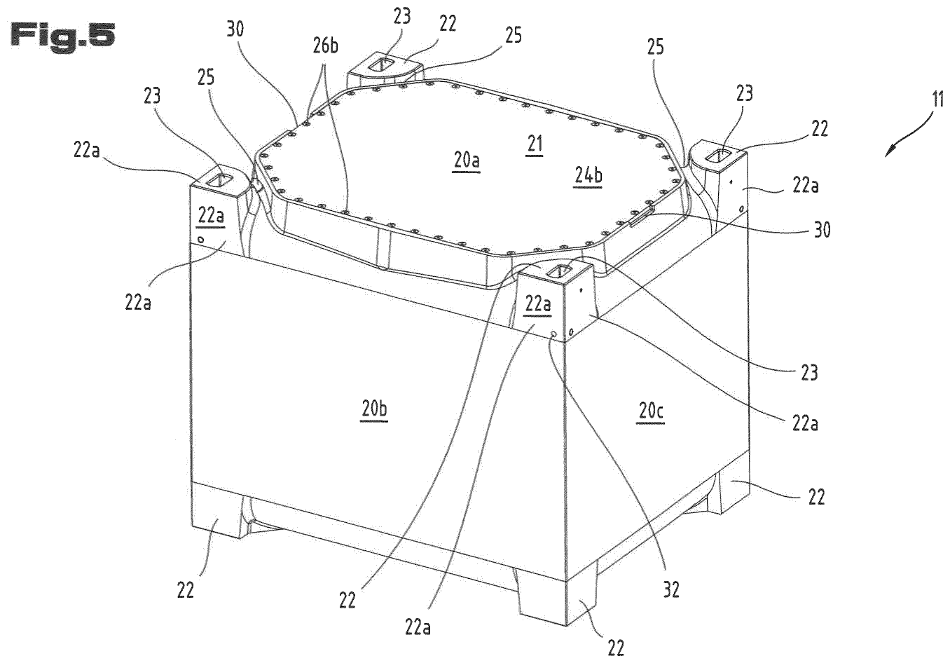

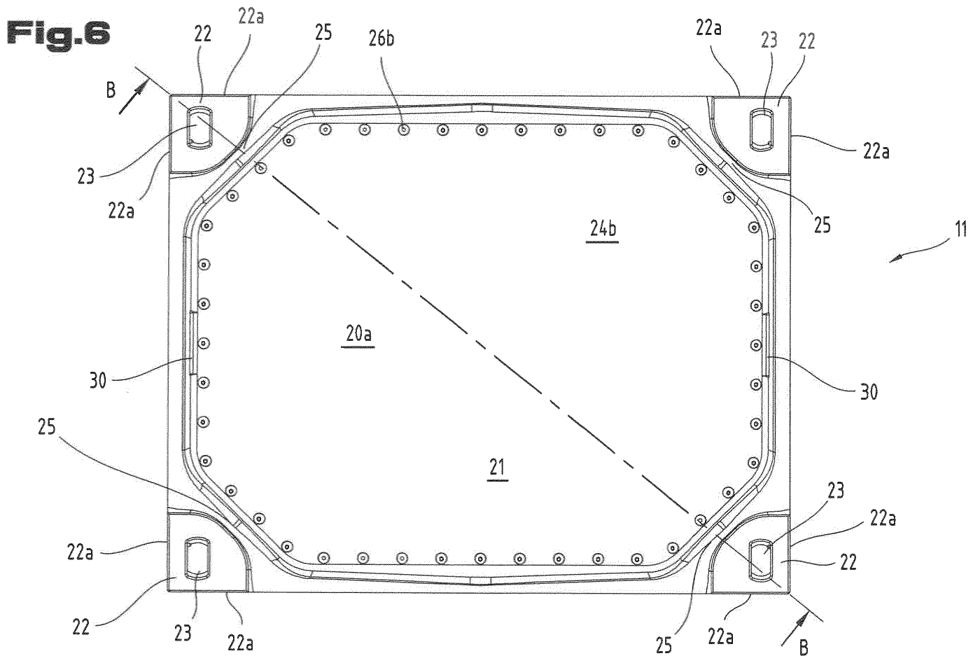

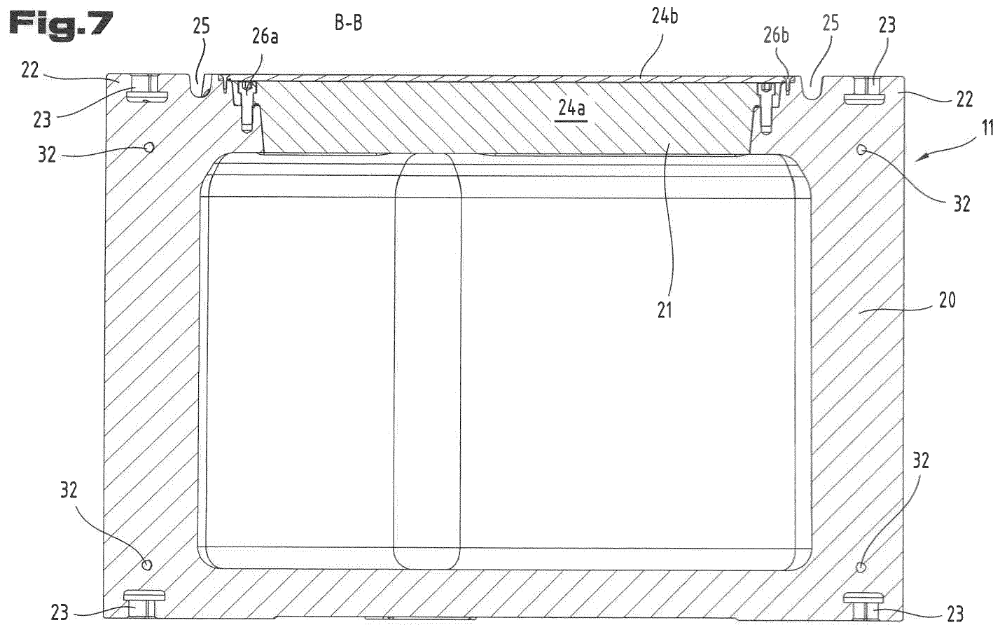

The radioactive waste container 11 according to a second embodiment of the present application depicted in FIGS. 5 to 7 is essentially the same as the container 10 of the first embodiment. The difference is, that the container sides 20a-f are flush with the corner surfaces or surfaces of the corner area 22a. The opening surface 20a and the bottom surface on which the container stands are depicted slightly recessed in the second embodiment since this is beneficiary in view of stacking the containers, however, the opening surface and/or the bottom surface may also be flush with the surfaces of the corner area 22a.

In both embodiments the recesses at least partially separating the respective corner or fixation from the opening are depicted as a continuous depression. However, each corner or fixation may be separated from the opening by multiple depressions or recesses or grooves. The recess(es) may be bridged by a rib that e.g. extends in a direction from the corner area that may comprise the fixation towards the opening.

In all figures like reference sings are used for like or similar parts/elements as in the other figures. Thus, a detailed explanation of such part/element will only be given one for the sake of brevity. The embodiments depict possible variations of carrying out the invention, however, it is to be noted that the invention is not limited to the depicted embodiments/variations but numerous combinations of the here described embodiments/variations are possible and these combinations lie in the field of the skills of the person skilled in the art being motivated by this description.

The scope of protection is determined by the appended claims. The description and drawings, however, are to be considered when interpreting the claims. Single features or feature combinations of the described and/or depicted features may represent independent inventive solutions. The object of the independent solutions may be found in the description. It is further to be noted that for a better understanding parts/elements are depicted to some extend not to scale and/or enlarged and/or down scaled.

### LIST OF REFERENCE SIGNS

10, 11 radioactive waste container (container)
20 container body
20a-f container sides
20a opening side
21 opening
22 corner(s)
22a corner surface(s)
23 fixation(s)
24a lid
24b cover
25 recess(es)
26a lid screw(s)
26b cover screw(s)
EB1 first enveloping body
EB2 second enveloping body
30 collar recess(es)
32 cross fixation(s)

1. Radioactive waste container (10, 11), comprising:
an essentially box-shaped hollow container body (20), having six container sides (20a-f) including an opening side (20a) that includes an opening (21) into the hollow container body,
wherein in at least one corner area (22) at which the container sides join, at least one fixation (23) is located,
wherein the opening is adapted to be closed with a lid (24a), and
wherein each corner area (22) adjacent to the opening is at least partially spaced from the opening by means of at least one recess (25) in the opening side.

2. Container (10) according to claim 1, wherein outside surfaces of the corners span a first enveloping body (EB1), wherein outside surfaces of the container sides span a second enveloping body (EB2), and wherein the second enveloping body is smaller than the first enveloping body.

3. Container (10, 11) according to claim 1, wherein at least the container body (20) is made from ductile cast iron.

4. Container according to claim 1, wherein the recess may comprise at least one rib that at least partially bridges the recess.

5. Container according to claim 1, further comprising a cover (24b) fitted into the opening (21).

6. Container according to claim 5, wherein a collar at least partially surrounding the cover (24b) includes at least one collar recess (30).

7. Container according to claim 1, further comprising at least one cross fixation (32) in at least one of the corner areas (22).
